(19) United States
(12) Patent Application Publication
(10) Pub. No.: US 2005/0232538 A1
(43) Pub. Date: Oct. 20, 2005

(54) Integrated optics multiplexer/demultiplexer comprising a cladding and method for making same

(75) Inventors: Christophe Martinez, Grenoble (FR); Denis Barbier, Grenoble (FR)

Correspondence Address: PILLSBURY WINTHROP SHAW PITTMAN, LLP, P.O. BOX 10500, MCLEAN, VA, 22102, US

(73) Assignee: Teem Photonics, Meylan (FR)

(21) Appl. No.: 10/513,495

(22) PCT Filed: May 13, 2002
(86) PCT No.: PCT/FR03/01441

§ 371 Date: Jun. 15, 2005

(51) Int. Cl. G02B 6/28

(52) U.S. Cl. 385/24; 385/14; 385/37

(57) ABSTRACT

This invention relates to a multiplexer/demultiplexer in integrated optics including n guide cores (23, 25) in a substrate (18), where n is an integer greater than or equal to 2, and at least one optical cladding (20) surrounding at least one portion of each of the n cores so as to define at least n interaction areas (I₁, I₂), each interaction area also comprising a grating (R₁, R₂), this multiplexer/demultiplexer comprising at least n inputs/outputs (P₁, P₂, P₃), formed by at least one end of each core. The invention is used for applications in all domains using wavelength multiplexers/demultiplexers, and particularly in the domain of optical telecommunications.

### TECHNICAL DOMAIN

This invention relates to a multiplexer/demultiplexer in integrated optics comprising an optical cladding and its manufacturing method.

The invention is used for applications in all domains using wavelength multiplexers/demultiplexers, and particularly in the domain of optical telecommunications.

### STATE OF THE PRIOR ART

At the present time, multiplexers/demultiplexers with optical claddings are made from optical fibres. An example of this type of component is given in the document “Wavelength-selective coupler and add-drop multiplexer using long-period fiber gratings” by V. Grusby et al., published in the OFC2000 conference held from Mar. 5 to 10, 2000 in Baltimore, USA.

FIG. 1 diagrammatically shows this type of component that comprises two optical fibres 1, 3 partially shown in this figure. The fibre 1 comprises a core 5 in which a grating 9 is formed and an optical cladding 7 surrounding the core. The fibre 3 comprises a core 15 in which a grating 19 is formed and an optical cladding 17 surrounding the core 15. The gratings 9 and 19 respectively induce an interaction area between the core and the cladding close to the corresponding grating, so that a light wave can be coupled from the core to the cladding or vice versa.

The two ends of these fibres are bonded to each other in a common coupling region 21 that is outside the interaction areas.

Thus, an initial light wave E comprising spectral bands with central wavelengths λⱼ, λₖ introduced in the core 5 of the fibre 1 is transported by the core to the grating 9. This grating provides a means of coupling the guided mode of the wave symbolically shown by arrows, to one or several cladding modes propagating in the optical cladding 7, in the same direction as the guided mode. Coupling between the different modes takes place for wavelengths λⱼ determined by the following known relation:
λⱼ=Λ×(n₀−nⱼ) (1)
where:
n₀ is the effective index of the guided mode,
nⱼ is the effective index of cladding mode number j,
λⱼ is the resonance wavelength for coupling to mode j;
Λ is the grating period.

This coupling results in an energy transfer between the guided mode and the cladding mode(s) for wavelengths λⱼ. Coupled energy in the cladding modes is then transmitted through the coupling region 21 to the cladding 17 of the fibre 3, while energy which is not coupled is transported by the core 5 to supply a light wave T with central wavelengths λₖ, corresponding to the light wave E, from which a part corresponding to the central wavelengths λⱼ has been extracted, to the output from the fibre 1.

Furthermore, the part of the light wave transmitted to the cladding 17 is then coupled by the grating 19 in the core 15 of the fibre 3 so as to obtain a light wave F output from the core 15, with central wavelengths λⱼ.

In multiplexers/demultiplexers made with optical fibres, each core is dependent on the optical cladding in which it is formed; the cladding has a refraction index lower than the refraction index of the core, to enable propagation of a light wave in the core. The core cannot exist without the optical cladding; optical fibres have to be superposed, and therefore coupling regions between the fibres are necessary, before wavelengths may be multiplexed/demultiplexed.

Coupling regions are difficult to make. In particular, fibres in these regions have to be polished and glued while avoiding creating optical losses, to obtain good coupling.

### SUMMARY OF THE INVENTION

The purpose of this invention is to divulge an integrated optics multiplexer/demultiplexer with at least one optical cladding, without the coupling problems of multiplexers/demultiplexers according to prior art.

Another purpose is to divulge a multiplexer/demultiplexer with at least one optical cladding that is independent of the guide cores to which it is associated. Independence of the core and the cladding means that they can exist in a substrate independently of each other.

More precisely, the invention relates to a multiplexer/demultiplexer including at least n guide cores in a substrate, where n is an integer greater than or equal to 2, and at least one optical cladding surrounding at least one portion of at least two distinct cores so as to define at least n interaction areas, each interaction area also comprising a grating enabling optical coupling between the core and the cladding in the interaction area, this multiplexer/demultiplexer comprising at least n inputs/outputs.

Thus, when this component is used as a demultiplexer, an input light wave with several spectral bands is added into one of the interaction areas through an input/output, the different interaction areas are such that each interaction area is suitable for providing a light wave with at least one of the spectral bands from the input wave, on an input/output.

Conversely, when this component is used as a multiplexer, p input light waves with determined spectral bands are introduced into p interaction areas through an input/output, a distinct light wave being introduced into each area, the different interaction areas are such that the input light waves are transported through different interaction areas so as to be coupled in at least one interaction area that then outputs a light wave with all or some of the spectral bands of the input waves on an input/output.

A multiplexer/demultiplexer can also be provided for which interaction areas have mixed operation, in other words they enable demultiplexing of spectral bands of a light wave and multiplexing of the spectral bands from several light waves.

A spectral band is a band with a set of wavelengths with determined central wavelength and band width.

Each light wave may comprise one or several spectral bands, the p light waves possibly having identical spectral bands.

The multiplexer/demultiplexer according to the invention can be used in particular, for example to make a spectral filter, but also to make an add and drop module, or a spectral coupler.

According to one preferred embodiment of the invention, each core comprises two ends, the n inputs/outputs are formed by at least one end of each core.

In the invention, the cladding is made artificially in the substrate, which enables the cores and the cladding to exist in the substrate independently of each other.

Independence of the cladding and the cores means that the n interaction areas can be made in the same cladding, so that it is possible to no longer have a coupling region between each optical cladding, as was the case for optical fibres according to prior art.

Furthermore, independence of the cores and the cladding advantageously enables the cladding to surround a portion of the guide cores. Thus, the cladding only acts on the propagation of a light wave in each core only in the area of the core that it surrounds and the cladding can guide or transport light waves independently of the cores.

Furthermore, since the cladding is independent of the cores, the cladding and core parameters can easily be adapted to the required applications. Thus, the dimensions, the value of the refraction index and the position of the cladding can easily be varied, to differ from the dimensions and value of the refraction index for each guide core. Thus, at least one characteristic of the mode(s) propagating in a guide core and/or one of the propagation modes in the cladding, can be modified.

The cladding has a refraction index greater than the refraction index of the substrate at least in the said area, so that cladding propagation modes can be induced in an interaction area.

The grating of an interaction area may be formed in the corresponding core of the area and/or the cladding.

Thus, when a light wave is introduced into the interaction area through the guide core, the guide mode is then coupled to one or several cladding modes in the interaction area, and vice versa the cladding mode(s) is (are) coupled to the core guided mode in the interaction area when the light wave is introduced into the cladding.

The grating may be periodic or pseudo periodic, and it may also be composed of a sequence of gratings.

The gratings in each interaction area may be identical or different, depending on the target applications.

The cladding may surround several portions of the same core so as to form several interaction areas in series, with the same core.

In a given cladding, the interaction areas may be in series and/or in parallel.

The substrate used may obviously be made using a single material or by superposition of several layers of material. In the latter case, the refraction index of the cladding is not the same as the refraction index of the substrate, at least in layers adjacent to the cladding.

According to one preferred embodiment, the cladding and the cores are made from the substrate, by a modification of the refraction index of the substrate.

According to the invention, the guides may be plane guides when light is confined in a plane containing the direction of propagation of light or microguides, when light is confined in two directions transverse to the direction of propagation of light.

Many multiplexer/demultiplexer variants can be made by combining guide cores with optical claddings, each created interaction area comprising a grating.

According to a first embodiment, the multiplexer/demultiplexer comprises one optical cladding and n guide cores, the optical cladding surrounds each core in a distinct interaction area, so as to form n interaction areas in series.

According to a second embodiment, the multiplexer/demultiplexer comprises m optical claddings, each optical cladding i surrounding nᵢ guide cores (where i is an integer from 1 to m) in distinct interaction areas so as to form nᵢ interaction areas in series for each cladding i, each cladding comprising at least one interaction area with a core common to an interaction area of another cladding.

In this embodiment, the claddings are made in parallel in the substrate. Each cladding i may comprise the same number nᵢ of interaction areas, or a different number as a function of the target applications.

According to a third embodiment, the multiplexer/demultiplexer comprises one optical cladding and n guide cores, the optical cladding surrounds each core in a distinct interaction area, so as to form n interaction areas in parallel.

According to a fourth embodiment, the multiplexer/demultiplexer comprises one optical cladding and n guide cores, the optical cladding surrounds each core so as to form one or several interaction areas in series with each core, and interaction areas in parallel with the different cores.

In this embodiment, the number of interaction areas is greater than the number n of cores, these interaction areas being arranged in series and in parallel.

Obviously many other embodiments are possible, particularly by combining the previous embodiments.

Advantageously, the substrate is made of glass.

Obviously, the substrate could also be made from other materials, for example such as crystalline materials such as KTP or LiNbO₃, or LiTaO₃.

Furthermore, the optical claddings and/or guide cores and/or gratings may be made by any type of technique capable of modifying the refraction index of the substrate. In particular, there are ion exchange, ionic implantation and/or radiation techniques, for example by laser insolation or laser photo writing.

More generally, gratings may be made by any technique capable of changing the effective index of the substrate. In addition to the above-mentioned techniques, in particular there are techniques for making gratings by etching the substrate close to interaction areas. This etching may be done above interaction areas or in the portion of the cladding in the interaction area and/or possibly in the portion of the cores in the interaction area.

Grating patterns may be obtained either by laser scanning if radiation is used, or by a mask. This mask may be the mask used to obtain cores and/or claddings, or a specific mask for making gratings.

The invention also relates to a process for making a multiplexer/demultiplexer in integrated optics, such as that previously defined including at least n guide cores in a substrate and at least one optical cladding, the cores, and the cladding being made by modifying the refraction index of the substrate such that the refraction index of the cladding is different from the refraction index of the substrate and is less than the refraction index of the cores, at least in the part of the cladding adjacent to the cores and at least in the interaction areas.

The refraction index of the substrate is modified particularly by radiation, for example by laser insolation or by laser photo writing and/or by introduction of ionic species.

According to one preferred embodiment, the process according to the invention includes the following steps:
a) introduction of a first ionic species into the substrate so as to obtain the optical cladding after step c),
b) introduction of a second ionic species into the substrate so as to obtain guide cores after step c),
c) burial of ions introduced in steps a) and b), so as to obtain the cladding and the guide cores.

Obviously the order of steps a) and b) could be reversed.

The first and/or second ionic species is advantageously introduced by ion exchange, or by ionic implantation.

The first and second ionic species may be the same or they may be different.

The first ionic species and/or the second ionic species may be introduced with application of an electric field.

In the case of an ion exchange, the substrate must contain ionic species that can be exchanged.

According to one preferred embodiment of the invention, the substrate is made of glass and contains previously introduced Na+ ions, and the first and second ionic species are Ag+ and/or K+ ions.

According to a first embodiment, step a) includes production of a first mask comprising a pattern that is suitable for producing the cladding, the first ionic species being introduced through this first mask, and step b) includes elimination of the first mask and production of a second mask containing a pattern suitable for producing cores, the second ionic species being introduced through this second mask.

The masks used in the invention may for example be made of aluminium, chromium, alumina or a dielectric material.

According to a first embodiment of step c), the first ionic species is buried at least partially before step b) and the second ionic species is buried at least partially after step b).

According to a second embodiment of step c), the first ionic species and the second ionic species are buried simultaneously after step b).

Advantageously, at least part of the burial is done including the application of an electric field.

According to a third embodiment of step c), burial includes a deposition of at least one layer of material with refraction index advantageously less than the refraction index of the cladding, on the surface of the substrate.

Obviously, this embodiment may be combined with the previous two embodiments.

In general, before burial under a field and/or deposition of a layer, the process according to the invention may also comprise burial by rediffusion in an ionic bath.

This rediffusion step may be done partly before step b) to rediffuse ions in the first ionic species and partly after step b) to rediffuse ions in the first and in the second ionic species. This rediffusion step may also be done entirely after step b), to rediffuse ions in the first and second ionic species.

For example, this rediffusion is obtained by dipping the substrate in a bath containing the same ionic species as that previously contained in the substrate.

Other characteristics and advantages of the invention will become clearer after reading the following description given with reference to the figures in the appended drawings. This description is given purely for illustrative purposes and is not limitative.

### BRIEF DESCRIPTION OF THE FIGURES

FIG. 1, already described, diagrammatically shows a section through a filter made according to prior art using optical fibres,

FIG. 2 diagrammatically shows a section through an example embodiment of a multiplexer/demultiplexer according to the invention comprising an optical cladding with two interaction areas in series formed from two cores,

FIG. 3 diagrammatically shows a section through an example embodiment according to the invention of a multiplexer/demultiplexer comprising an optical cladding with three areas of interaction in series formed from three cores,

FIG. 4 diagrammatically shows a section through an example embodiment according to the invention of a multiplexer/demultiplexer comprising two optical claddings, with two interaction areas in series formed from two cores, in each cladding,

FIG. 5 diagrammatically shows a section through an example embodiment according to the invention of a multiplexer/demultiplexer comprising four optical claddings, with two interaction areas in series formed from two cores, in each cladding,

FIG. 6 diagrammatically shows a section through an example embodiment according to the invention of a multiplexer/demultiplexer comprising an optical cladding with two interaction areas in parallel formed from two cores,

FIG. 7 diagrammatically shows a section through an example embodiment according to the invention of a multiplexer/demultiplexer comprising an optical cladding with three interaction areas in parallel formed from three cores,

FIG. 8 diagrammatically shows a section through an example embodiment according to the invention of a multiplexer/demultiplexer comprising an optical cladding with four interaction areas in parallel formed from two cores,

FIG. 9 diagrammatically shows a section through an example embodiment according to the invention of a multiplexer/demultiplexer comprising a grating formed from several gratings in series, in each interaction area,

FIGS. 10a to 10d illustrate a section through an example embodiment of a multiplexer/demultiplexer according to the invention,

FIGS. 11a to 11d illustrate variant embodiments of a mask pattern for obtaining a grating in a core, and

FIG. 12 shows a section through a variant embodiment of a component according to the invention with a grating in a cladding.

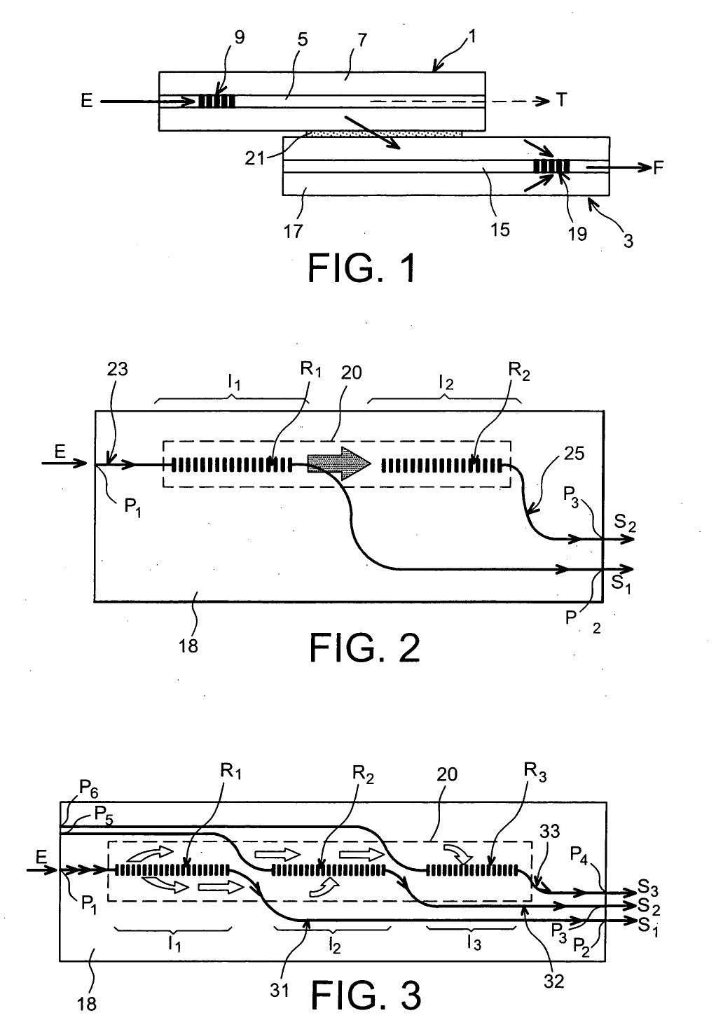

### DETAILED DESCRIPTION OF EMBODIMENTS OF THE INVENTION

Claddings with a constant refraction index are described for simplification reasons, but obviously it would be quite possible to use claddings with a variable index within the scope of this invention, provided that their indexes close to the core are smaller than the refraction index of the core.

Similarly, although the substrate may include one layer or several layers, all these figures represent a substrate with a single layer.

Furthermore, these figures only show the multiplexer/demultiplexer, but obviously other elements could be integrated in the same substrate.

The multiplexer demultiplexer shown diagrammatically in section in FIG. 2, comprises an optical cladding 20 and two optical guide cores 23, 25. The cladding 20 surrounds a portion of the two cores 23, 25 so as to define two interaction areas I₁, I₂ in series; the interaction area I₁ comprising a grating reference R₁ and the interaction area I₂ comprising a grating reference R₂. This multiplexer/demultiplexer also comprises three inputs/outputs; a first input/output P₁ formed by one of the ends of the core 23, a second input/output P₂ formed by the other end of the core 23, and a third input/output P₃ formed one of the ends of the core 25. In this example embodiment, the other end of the core 25 is located in the cladding facing the interaction area I₁, although it would also have been possible, as in the case in FIG. 3, to place this end outside the cladding to form an additional input/output.

In this Figure, the optical cladding 20 only surrounds the portion of the core 23 that includes the grating R₁ and the portion of the core 25 that includes the grating R₂. The substrate area that includes the cladding, the core 23 and the grating R₁ is the interaction area I₁ and the substrate area that includes the cladding, the core 25 and the grating R₂ is the interaction area I₂.

It is quite clear in these figures that the cores 23 and 25 exist independently of the cladding 20 since outside the interaction areas, the cores are no longer located in the cladding, but only in the substrate 18 that enables optical isolation of the cores.

The cladding is thus created artificially in the substrate, at least around a portion of the cores comprising the gratings and independently of the cores and the substrate.

In general, an artificial cladding refers to this type of cladding made according to the invention, and a grating with artificial cladding (ACG) when the interaction area comprises a grating.

In this example embodiment, and in the following embodiments, the cladding is made in the substrate so as to have a refraction index between the refraction index of the substrate and the refraction index of the guide cores, so that it is possible to have cladding modes due to the presence of the gratings (represented by arrows in the cladding).

The gratings made in the interaction areas are a sequence of periodic or pseudo-periodic patterns represented in these examples by segmentation of the cores.

Since the cladding is independent from the guide cores, it is possible to adapt cladding parameters (such as dimensions, the index and the position) to suit core parameters (such as the dimensions, the indexes and the positions) to target applications.

The coupling force between a guided mode and a mode of cladding j given on a spectral band with central wavelength defined by relation (1), is obtained by taking the product of the grating length and the coupling coefficient κ. This coupling coefficient is proportional to the overlap integral of the two coupled modes, weighted by the grating profile.

We will denote the transverse profiles of guided and cladding modes as ξ₀ and ξⱼ respectively and the grating profile Δn, the coupling coefficient κ is then given by a relation of the following type:
κ∝∫∫ξ₀,ξ*ⱼ.Δn.ds (2)
where ds is an integration element over the entire transverse surface of the substrate, in other words in a plane perpendicular to the propagation axis of the wave.

Thus, as the dimensions and index at the cladding increase, the number of cladding modes that could propagate will increase and therefore there will be a high possibility of coupling spectral bands. Conversely, if it is required to limit the number of cladding modes that can be coupled, it is useful to reduce the opto-geometric dimensions of the cladding.

The dimensions and index of the guide cores are independent and affect the characteristics of modes that propagate in them, and for example enable them to adapt to fibre modes in the case of coupling between the guide core and the fibre core.

Furthermore, as the differences between the indexes of the cores, the cladding and the substrate increase, the possibility of having couplings for short grating periods also increases, as shown by relation (1) (at a given resonance wavelength, the period is inversely proportional to the difference in index between guided and cladding modes).

Grating dimensions may also be adapted to target applications. Thus, it is possible to use gratings with long periods (for example a few tens of μm to several thousand μm) and gratings with shorter periods (for example less than a few μm) such as blazed gratings or gratings with inclined lines.

In the case shown in FIG. 2, when this component is used as a demultiplexer (as shown by the direction of the arrows that symbolically show propagation of light waves in this figure), an input light wave E with several spectral bands is introduced into it by the input P₁ and is transported in the core 23 as far as the interaction area I₁. In this area, the parameters of the grating with artificial cladding (in other words the combination of the grating, the core and the cladding) are such that the light wave is coupled to the mode(s) of the cladding 20 for one or several spectral bands while the spectral band(s) of the part S₁ of the uncoupled wave is (are) transported through the core 23 to the output P₂ of the component.

The coupled part of the light wave in the cladding is then transmitted to the interaction area I₂ and then, for all or part of its spectral bands, is coupled through the grating R₂ with artificial cladding for which the parameters are adapted to this coupling, in the core 25. The coupled part S₂ of the wave in the core 25 is transmitted through the core 25 to the output P₂ of the component.

For example, if the wave E has two spectral bands with central wavelengths equal to λ₁ and λ₂ respectively, parameter settings are made for the grating R₁ with artificial cladding such that the wave S₁ has a spectral band with central wavelength λ₁ and parameter settings are made for the grating R₂ with artificial cladding such that the wave S₂ has a spectral band with central wavelength λ₂.

Conversely, when this component is used as multiplexer, two input light waves S₁ and S₂ with determined spectral bands are introduced through inputs P₂ and P₃ in interaction areas I₁ and I₂ respectively. All or some of the spectral bands of the wave S₂ transported by the core 25 are coupled through the grating R₂ with artificial cladding to the cladding mode(s), all or some of the spectral bands of these cladding modes in the core 23 are then coupled through the grating R₁ with artificial cladding. Furthermore, the wave S₁ transported by the core 23 passes the interaction area I₁, at least some of its spectral bands are not coupled to the cladding mode(s) through the grating R₁ such that at the output P₁ from the component, the wave E comprises spectral bands of S₁ and spectral bands of S₂, parameter settings are made for the gratings R₁ and R₂ with artificial cladding so as to multiplex these spectral bands.

Thus, for example, if the wave S₁ has a spectral band with central wavelength λ₁ and wave S₂ has a spectral band with central wavelength λ₂, parameter settings are made for the gratings R₁ and R₂ with artificial cladding such that the wave E has spectral bands with central wavelengths λ₁ and λ₂.

FIG. 3 shows a variant of FIG. 2 in which the multiplexer/demultiplexer diagrammatically shows a section through a substrate 18 showing an optical cladding 20 and three cores 31, 32 and 33 of optical claddings. The cladding 20 surrounds a portion of each of the three cores so as to define three interaction areas I₁, I₂ and I₃ in series; interaction area I₁ comprising a grating R₁, interaction area I₂ comprising a grating R₂ and interaction area I₃ comprising a grating R₃. This multiplexer/demultiplexer also comprises six inputs/outputs corresponding to the two ends of each core. Inputs/outputs P₁, P₂ formed by the ends of the core 31, inputs/outputs P₅, P₃ formed by the ends of the core 32 and inputs/outputs P₆, P₄ formed by the ends of the core 33. In this example embodiment, the multiplexer/demultiplexer can be used in both directions depending on the target application; in other words, operation in demultiplexer is possible by considering P₁ as an input and P₂, P₃ and P₄ as outputs (this is the operation shown in FIG. 3), the arrows symbolically showing propagation of light waves); and operation in multiplexer may be made by considering P₂, P₃, P₄ as inputs and P₁ as an output.

For example, if the wave E introduced into the component has three spectral bands with central wavelengths equal to λ₁, λ₂, λ₃ respectively, parameter settings are made for the grating R₁ such that the wave S₁ on the output P₂ has a spectral band with central wavelength λ₁, the grating R₂ with artificial cladding is defined by parameters such that the wave S₂ on the output P₃ has a spectral band with central wavelength λ₂ and parameter settings are made for the grating R₃ with artificial cladding such that the wave S₃ on the output P₄ has a spectral band with central wavelength λ₃. If three light waves S₁ with a spectral band with central wavelength λ₁, S₂ with a spectral band with central wavelength λ₂, and S₃ with a spectral band with central wavelength λ₃ are introduced, parameter settings are made for the gratings R₁, R₂, R₃ with artificial cladding such that the wave E at the output P₁ has spectral bands with central wavelengths λ₁, λ₂, λ₃ respectively.

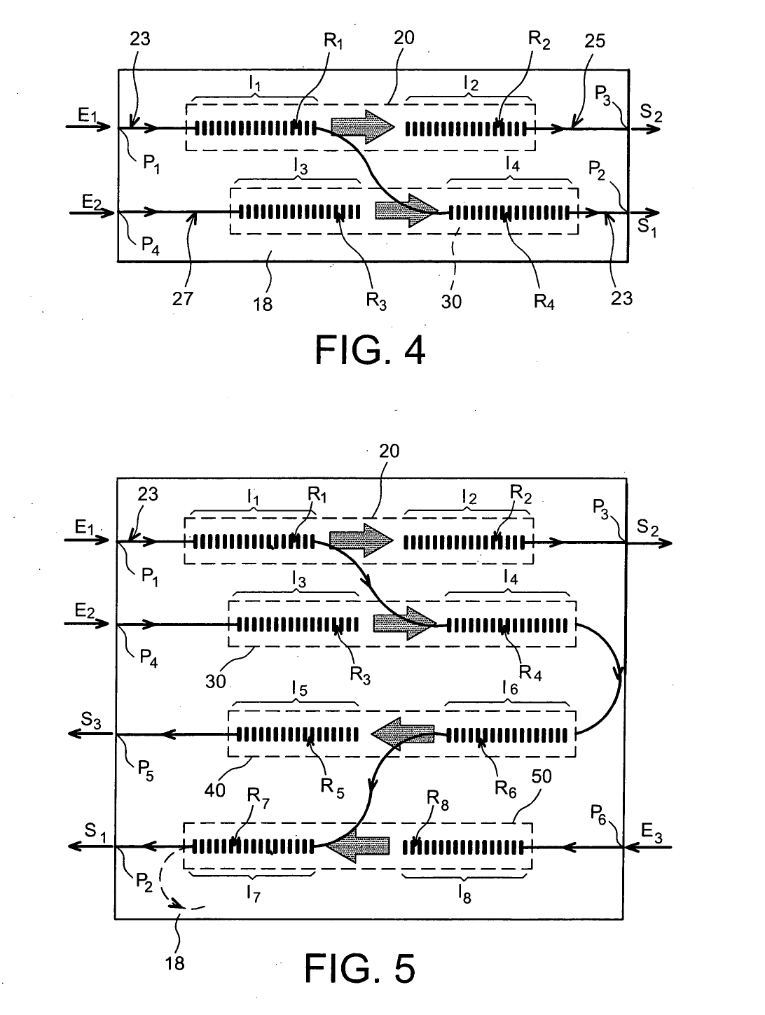

FIG. 4 diagrammatically shows a sectional view through an example embodiment according to the invention, of a multiplexer/demultiplexer comprising two optical claddings 20, 30 arranged in parallel in substrate 18, each cladding containing two interaction areas in series formed from two cores as in FIG. 2. Thus, interaction areas I₁, and I₂ comprising gratings R₁ and R₂ respectively are in series, interaction areas I₃ and I₄ containing gratings R₃ and R₄ respectively are also in series, while areas I₁ and I₂ are arranged in parallel with areas I₃ and I₄. This component comprises four cores; a core 23 common to interaction areas I₁ and I₄, a core 25 for producing the interaction area I₂ and a core 27 for producing the interaction area I₃.

This component comprises four inputs outputs P₁, P₂, P₃, P₄, and is symmetric in its operation. With this type of component, two light waves can be introduced through P₁, P₄, and two light waves can be recovered at the output through P₂, P₃; similarly, two light waves can be introduced through P₂, P₃, and two light waves can be recovered at the output through P₁, P₄.

For example, if a light wave E₁ with spectral bands with central wavelengths λ₁, λ₂ is introduced through P₁, and a wave E₂ with a spectral band with central wavelength λ₃ is introduced through P₄, parameter settings are made for the different gratings R₁, R₂, R₃, R₄ with artificial cladding such that at the output P₂, the recovered wave S₁ has spectral bands with central wavelengths λ₂, λ₃ and at output P₃, the recovered wave S₂ has a spectral band with central wavelength λ₁.

In the special case in which λ₁=λ₃, the component of FIG. 4 acts as an add and drop module.

FIG. 5 diagrammatically shows a variant embodiment of FIG. 4 in which the multiplexer/demultiplexer comprises four optical claddings in parallel with two interaction areas in series in each cladding, formed from two cores, the core of one of the interaction areas of each cladding being the same.

This example embodiment is also symmetrical, and comprises three inputs (for example P₁, P₄, P₆) and three outputs (for example P₂, P₃, P₅).

For example, if a wave E₁ with spectral bands with central wavelengths λ₁, λ₂, λ₃ is introduced through P₁, and a wave E₂ with a spectral band with central wavelength λ₄ is introduced through P₄, and a wave E₃ with spectral band with central wavelength λ₅ is introduced through P₆, parameter settings are made for the different gratings with artificial cladding R₁ to R₈ such that the wave S₁ recovered at output P₂ has a spectral band with central wavelengths λ₄, λ₂, λ₅, the wave S₂ recovered at output P₃ has a spectral band with central wavelength λ₁ and the wave S₃ recovered at output P₅ has a spectral band with central wavelength λ₃.

This example with four claddings may be made with a larger number m of claddings. The dashed lines in FIG. 5 at one end of the core 23 extrapolate the possibility of adding other claddings.

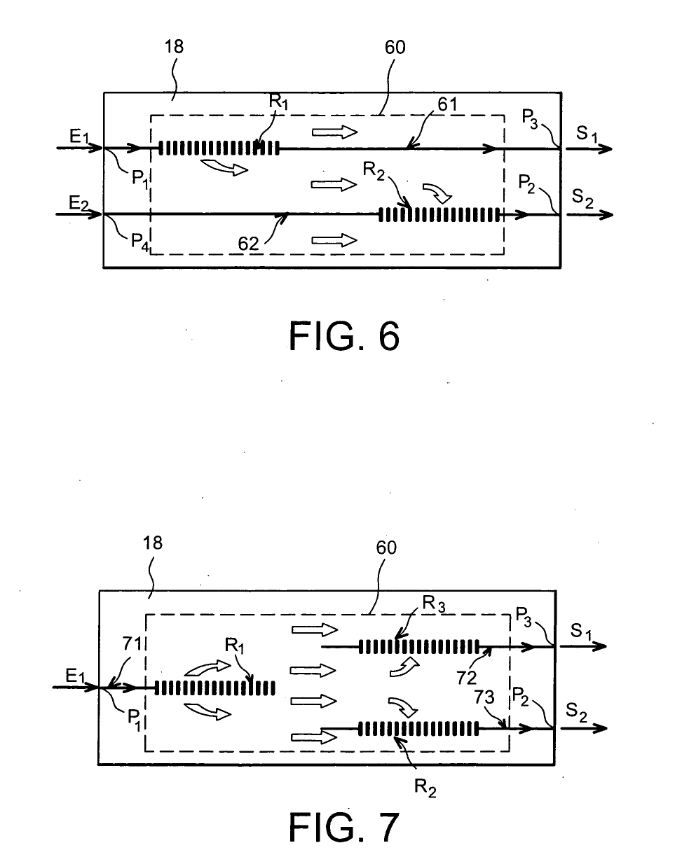

FIG. 6 diagrammatically shows a section through an example embodiment according to the invention of a multiplexer/demultiplexer comprising a single optical cladding 60 in a substrate 18, with two interaction areas in parallel formed from two cores 61, 62 and gratings R₁ and R₂ in parallel.

This component as shown is also symmetrical. It comprises four inputs/outputs, including two inputs (for example P₁, P₄) and two outputs (for example P₂, P₃).

In operation with a single input, for example P₁, if a wave E₁ is introduced with spectral bands with central wavelengths λ₁, λ₂, waves S₁ are S₂ are recovered through gratings R₁, R₂ with artificial cladding on outputs P₃, P₂ respectively, wave S₁ having a spectral band with central wavelength λ₁ and wave S₂ having a spectral band with central wavelength λ₂.

Use of the input P₄ makes it possible to introduce a wave E₂ into the core 62, for which the spectral band(s) may be added onto the output P₂ at the spectral band with central wavelength λ₂ of the wave S₂. Therefore this special case enables operation both in multiplexer and demultiplexer.

In this example, the grating R1 and the grating R2 have at least one of the common spectral bands.

FIG. 7 diagrammatically shows a section through an example embodiment of a multiplexer/demultiplexer according to the invention comprising a single optical cladding 60 with three interaction areas in parallel formed from three cores 71, 72, 73 and gratings R1, R2, R3 in parallel, in a substrate 18.

This component comprises three inputs/outputs. Only one of the ends of each core forms an input/output, the other ends of the cores face inwards into the cladding 60.

For example in operation as demultiplexer, a wave E₁ with spectral bands with central wavelengths λ₁, λ₂ is introduced through input P₁, and a wave S₁ with a spectral band with central wavelength λ₁ is recovered at the output P₃ from this component, and a wave S₂ with a spectral band with a spectral band with central wavelength λ₂ is recovered at the output P₂.

In the special case in which λ₁=λ₂, the component in FIG. 7 acts as a divider/combiner.

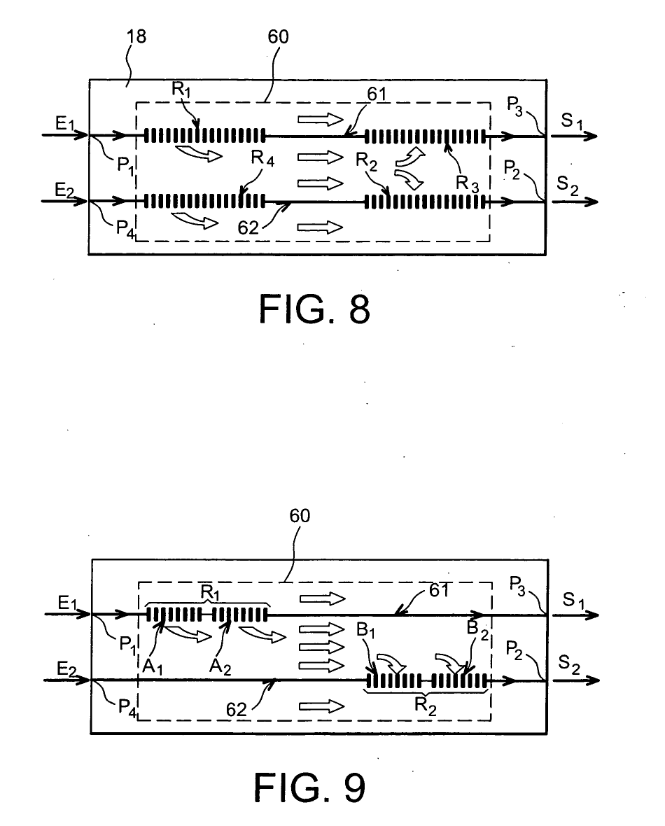

FIG. 8 diagrammatically shows a section through an example embodiment according to the invention of a multiplexer/demultiplexer comprising interaction areas in series and in parallel. The difference between this multiplexer/demultiplexer and that shown in FIG. 6 is that there are two additional interaction areas, one formed from the core 61 and a grating R₃, and the other from the core 62 and a grating R₄. Thus, this component comprises two interaction areas in series for each core (associated with gratings R₁ and R₃ for the core 61 and gratings R₂ and R₄ for the core 62), the interaction areas in series of one core being in parallel with the interaction areas in series of the other core.

For example, considering operation as demultiplexer, the use of additional gratings R₃ and R₄ makes it possible to also couple in the core 61 all or some of the light wave E₂ introduced into the core 62 through the input P₄, which was not the case in FIG. 6. This component is symmetrical.

Finally, FIG. 9 diagrammatically shows a section through an example embodiment of a multiplexer/demultiplexer according to the invention comprising a grating formed by several gratings in series, in each interaction area. The multiplexer in FIG. 9 is of the same type as the multiplexer in FIG. 6. The only difference is that the grating R₁ is made from two distinct gratings A₁, A₂ and grating R₂ is made from two distinct gratings B₁, B₂.

Thus, if the gratings A₁ and B₁ can be used to couple a determined spectral band and gratings A₂ and B₂ can be used to couple another determined spectral band, and if a wave E₁ with spectral bands with central wavelengths λ₁, λ₂, λ₃ are introduced at input P₁, it is possible to recover a wave S₁ with spectral band with central wavelength λ₁ on output P₃, and to recover a wave S₂ with spectral band with central wavelengths λ₂, λ₃ on output P₂, through grating R₁ (composed of A₁ and A₂) and grating R₂ (composed of B₁ and B₂).

Obviously, other example multiplexer/demultiplexer embodiments could be produced particularly by combining these variants. Furthermore, operation of the above examples of components has been presented essentially to demultiplex spectral bands of a light wave, but these components could also operate in the reverse direction, in other words to multiplex spectral bands of several light waves. Furthermore, the gratings used have been shown in cores, although these gratings can be made in claddings and/or in the cores.

An example embodiment of a multiplexer/demultiplexer will now be described. To simplify the description, we will describe the production of a single cladding, a single core and a single grating, to produce a single interaction area, for example I₁, those skilled in the art will easily be able to make all types of multiplexer/demultiplexer, and particularly those shown in the previous figures, from this description.

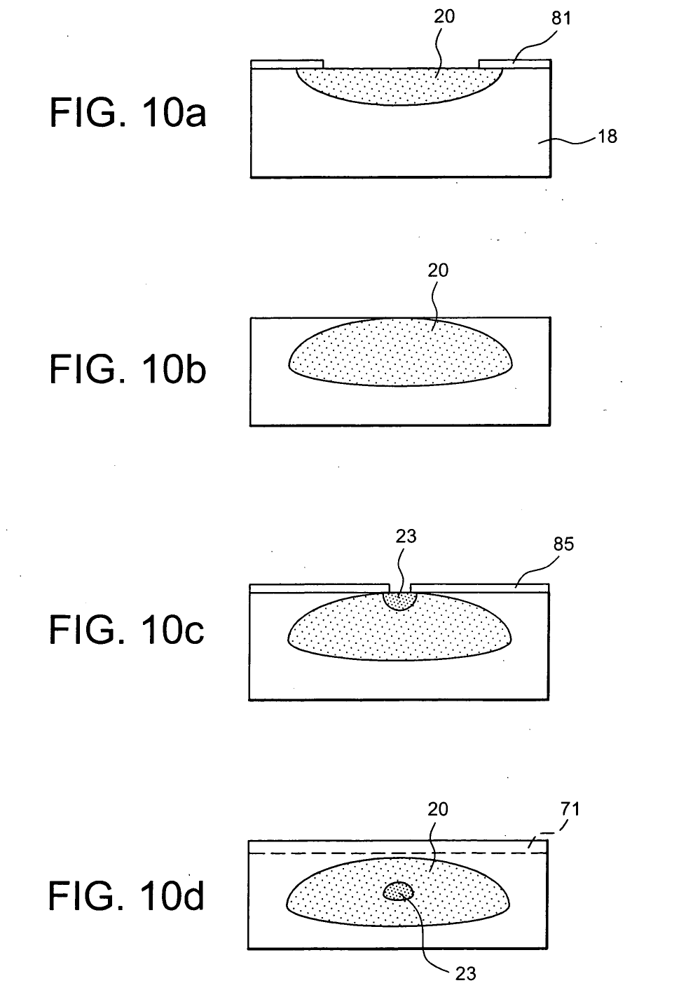

Thus, FIGS. 10a to 10b show sections through a plane perpendicular to the surface of the substrate and containing the interaction area I₁, illustrating an example process for making a multiplexer/demultiplexer according to the invention, starting from the ion exchange technology.

FIG. 10a shows the substrate 18 containing ions B.

A first mask 81 is made, for example by photolithography on one of the faces of the substrate; this mask comprises a determined opening as a function of the dimensions (width, length) of the cladding that is to be obtained. Furthermore, when the grating is made in the cladding, the patterns of the mask 85 may be adapted to the patterns of the grating to be formed.

A first ion exchange is then made between ions A and ions B contained in the substrate, in a substrate area located close to the opening of mask 81. This exchange is obtained for example by dipping the substrate with the mask into a bath containing ions A and possibly applying an electric field between the face of the substrate on which the mask is located and the opposite face. The substrate area in which this ion exchange takes place forms the cladding 20.

This cladding is buried by carrying out an ion rediffusion step A with or without the assistance of an electrical field applied as above. FIG. 10b shows the cladding after a partial burial step of the cladding. The mask 81 is usually removed before this step.

Therefore, the production of the cladding according to the invention is similar to the production of a guide core, but the dimensions are different.

The next step shown in FIG. 10c consists of forming a new mask 85 on the substrate, for example by photolithography, possibly after cleaning the face of the substrate on which it is made. This mask comprises patterns used to make the core 23 of the guide and particularly when the grating is made in the core, the patterns of the mask 85 can be adapted to the patterns of the grating to be formed.

A second ion exchange is then made between the B ions of the substrate and the C ions that may be the same as or different from the A ions. This ion exchange may be made as above by dipping the substrate in a bath containing C ions and possibly applying an electrical field.

Finally, FIG. 10d illustrates the component obtained after burial of the core 23 obtained by rediffusion of ions C and final burial of the cladding, with or without the assistance of an electrical field. The mask 85 is usually eliminated before this burial step.

Conditions for the first and second ion exchanges are defined so as to obtain the required differences in refraction indexes between the substrate, the cladding and the core. The adjustment parameters of these differences are particularly the exchange time, the bath temperature, the ion concentration in the bath and whether or not there is an electric field present.

As an example embodiment, the substrate 18 is made of glass containing Na+ ions, the mask 81 is made of aluminium and has an opening about 30 μm wide (the length of the opening depends on the required cladding length for the target application).

The first ion exchange is made with a bath containing Ag+ ions at a concentration of approximately 20%, a temperature of about 300° C. and for an exchange time of about 5 minutes. Rediffusion of ions takes place firstly in free air at a temperature of about 330° C. for 30 s, then the cladding thus formed in the glass is partially buried. This burial is done by rediffusion in a sodium bath at a temperature of about 260° C. for 3 minutes.

The mask 85 is also made of aluminium and has an opening pattern approximately about 3 μm wide (the pattern length depends on the required core length for the target application).

The second ion exchange is made with a bath also comprising Ag+ ions at a concentration of about 20%, a temperature of about 330° C. and for an exchange time of about 5 minutes, rediffusion of ions firstly in free air at a temperature of about 330° C. and for 30 s. The core thus formed in the glass is then partially buried by rediffusion in a sodium bath at a temperature of about 260° C. for 3 minutes.

Burial of the cladding and the core is finalized under an electric field, with the two opposite faces of the substrate being in contact with the two baths (in this example sodium), so that a potential difference between these two baths can be obtained.

Many variants of the process described above can be produced. In particular, burial steps of the cladding and the core may be performed as described above during two successive steps, but they may also be done simultaneously because the core gets buried faster than the cladding because it has a higher ionic concentration than the cladding, and this also enables centring of the core in the cladding.

The difference in concentration between the core and the cladding is usually obtained by rediffusion of ions forming the cladding in a bath, or by a difference in the concentration of ions introduced in steps a) and b).

As we have already seen, one variant of the process for burying the cladding and the core consists of depositing a layer of material 71, shown in dashed lines in FIG. 10d, on the substrate 18. To enable optical guidance, this material must advantageously have a refraction index less than the refraction index of the cladding.

The component according to the invention is produced not only using the ion exchange technique. The component according to the invention may obviously be made using any technique that can be used to modify the refraction index of the substrate.

Moreover, the period, size and position of the grating with respect to the core and the guide are parameters that may be adapted as a function of the application.

The grating pattern may be defined on the mask to produce the cladding and/or the mask so that the core can be produced, or on a specific mask for production of the grating only.

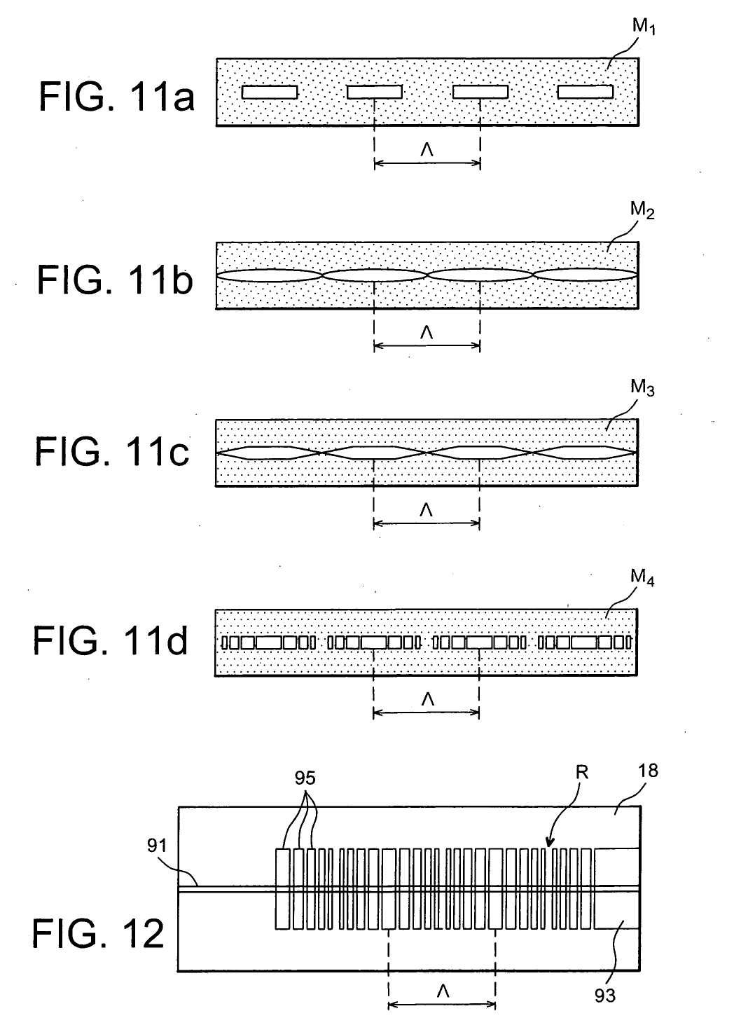

FIGS. 11a to 11d illustrate examples of variant embodiments of masks M₁, M₂, M₃, M₄ used to obtain a grating, for example R₁. These Figures show top views of masks and only show the part of the masks used to obtain the grating. White areas in the pattern of masks correspond to openings in the masks.

These masks can be used to obtain a periodic grating with period Λ.

For example, these masks may be specific masks for making the grating in the core and/or in the cladding, or part of the masks that can be used to obtain the core and/or the cladding, the grating then being made at the same time as the core and/or the cladding.

FIG. 12 illustrates an example embodiment of a grating R made in an interaction area common to a core 91 and a cladding 93.

Thus, in this Figure, the grating R is formed in the cladding by an alternation with period A of areas 95 with variable width considered in the direction of propagation of a light wave. These areas have an effective index different from the effective index of the remainder of the cladding due to a change in the refraction index in these areas. Moreover, the core is included in the cladding at least in the interaction area, the grating is also inscribed in the core, in other words the core also comprises areas with refraction index different from the refraction index for the rest of the core.

The gratings may be formed by any conventional technique for locally modifying the effective index of the substrate in the core and/or in the cladding.

Therefore, it can be done as described above, during ion exchanges used to make the core and/or the cladding or during a specific ion exchange. But, it may also be done by etching the substrate at the interaction area or by radiation. In particular, the grating may be obtained by insolation of the core and/or the cladding with a CO₂ type laser. The laser can locally rediffuse ions by creating local temperature rises, and thus inscribe the grating pattern.

For example, the substrate can be scanned with a laser beam, for example an amplitude modulated laser beam, so as to introduce a modulation of the grating at the required pitch.

The grating pattern depends on target applications. In particular, the grating may have a variable period (chirped grating), or variable efficiency (apodised grating).

1. A multiplexer/demultiplexer comprising:
a plurality of guide cores in a substrate;
a plurality of inputs/outputs; and
an optical cladding surrounding at least a portion of two distinct guide cores so as to define a plurality of interaction areas,
wherein each interaction area comprises a grating configured to optically couple a guide core in said plurality of guide cores and the optical cladding.

2. A multiplexer/demultiplexer according to claim 1, wherein each guide core in said plurality of guide cores comprises two ends and the plurality of inputs/outputs are formed by at least one end of each core.

3. A multiplexer/demultiplexer according to claim 1, wherein the optical cladding has a refractive index greater than a refractive index of the substrate, at least in the plurality of interaction areas.

4. A multiplexer/demultiplexer according to claim 1, wherein the grating of each interaction area is formed in a portion of a guide core in each interaction area and/or the cladding in each interaction area.

5. A multiplexer/demultiplexer according to claim 1, wherein the grating is at least one of periodic pseudo periodic, composed of a sequence of gratings, or a combination thereof.

6. A multiplexer/demultiplexer according to claim 1, wherein interaction areas in a given cladding are arranged in series and/or in parallel.

7. A multiplexer/demultiplexer according to claim 1, wherein the optical cladding surrounds each guide core in the plurality of guide cores so as to form the plurality of interaction areas in series.

8. A multiplexer/demultiplexer according to claim 1, further comprising:
a plurality of optical cladding, each optical cladding in said plurality of optical claddings surrounds at least one guide core in said plurality of guide cores in distinct interaction areas so as to form a plurality of interaction areas in series in each optical cladding,
wherein each optical cladding comprises at least one interaction area with a guide core common to an interaction area of another cladding.

9. A multiplexer/demultiplexer according to claim 1, wherein the optical cladding surrounds each guide core in the plurality of guide cores in a distinct interaction area, so as to form a plurality of interaction areas in parallel.

10. A multiplexer/demultiplexer according to claim 1, wherein the optical cladding surrounds each guide core in the plurality of guide cores so as to form at least one interaction area in series with each guide core, and to form interaction areas in parallel with the guide cores.

11. A process of making a multiplexer/demultiplexer in integrated optics, comprising:
forming a plurality of guide cores and a cladding of the multiplexer/demultiplexer in a substrate of the multiplexer/demultiplexer by modifying a refractive index of the substrate such that a refractive index of the cladding is different from the refractive index of the substrate and such that the refractive index of the cladding is less than a refractive index of the plurality of guide cores, at least in a part of a cladding adjacent to the guide cores and at least in interaction areas in a vicinity of the plurality of guide cores or the cladding.

12. A process of making according to claim 11,
wherein said modifying the refractive index of the substrate comprises modifying the refractive index of the substrate by using at least one of a radiation and/or introducing ionic species into the substrate.

13. A process of making according to claim 12, wherein said introducing ionic species into the substrate includes:
introducing a first ionic species into the substrate so as to obtain the optical cladding,
introducing a second ionic species into the substrate so as to obtain the guide cores,
burying the first and second ionic species so as to obtain the cladding and the guide cores.

14. A process of making according to claim 13, wherein the first and/or second ionic species is introduced by ion exchange, or by ionic implantation.

15. A process of making according to claim 14, wherein introducing the first ionic species and/or the second ionic species comprises applying an electric field.

16. A process of making according to claim 14, wherein the substrate comprises glass and contains Na+ ions, and the first and second ionic species comprise Ag+ and/or K+ ions.

17. A process of making according to claim 13 wherein
introducing a first ionic species into the substrate so as to obtain the optical cladding includes manufacturing a first mask marked with a pattern suitable for obtaining the optical cladding, and introducing the first ionic species through this first mask, and
introducing a second ionic species into the substrate so as to obtain the guide cores includes eliminating the first mask and manufacturing a second mask with a pattern suitable for obtaining the guide cores, and introducing the second ionic species through the second mask.

18. A process of making according to claim 13, wherein burying the first ionic species is done at least partially before introducing the second ionic species into the substrate so as to obtain the guide cores and wherein burying the second ionic species is done at least partially after introducing the second ionic species into the substrate so as to obtain the guide cores.

19. A process of making according to claim 13, wherein burying the first and second ionic species are done simultaneously after introducing the second ionic species into the substrate so as to obtain the guide cores.

20. A process of making according to claim 13, wherein at least a part of burying the first and/or the second ionic species includes applying an electric field.

21. A process of making according to claim 13, wherein at least part of burying the first and/or the second ionic species includes re-diffusing in an ionic bath.

22. A process of making according to claim 13, wherein all or part of burying the first and/or the second ionic species includes depositing at least one layer on a surface of the substrate.

23. A process of making according to claim 11,
further comprising modifying an effective refractive index of the substrate in the cladding in an interaction area and/or modifying an effective refractive index of the substrate in a guide core in an interaction area according to a selected pattern to obtain a grating in each interaction area.

24. A process of making according to claim 23, wherein the selected grating pattern is obtained by adding ionic species through a mask for obtaining the guide core and/or the cladding or through another mask.

25. A process of making according to claim 23, wherein the selected grating pattern is obtained by creating local temperature rises.

26. A process of making according to claim 23, wherein the selected grating pattern is obtained by etching the substrate.
